(19) United States
(12) Patent Application Publication
(10) Pub. No.: US 2007/0120858 A1
(43) Pub. Date: May 31, 2007

(54) Generation of motion blur

(75) Inventor: Kornelis Meinds, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/572,845

(22) PCT Filed: Sep. 16, 2004
(86) PCT No.: PCT/IB04/51780

§ 371 Date: Mar. 21, 2006

(30) Foreign Application Priority Data
Sep. 25, 2003 (EP) 03103558.7

(51) Int. Cl. G06T 15/70

(52) U.S. Cl. 345/473

(57) ABSTRACT

In a method of generating motion blur in a 3D-graphics system, geometrical information (GI) defining a shape of a graphics primitive (GP) is received (RSS; RTS) from a 3D-application. A displacement vector (SDV; TDV) defining a direction of motion of the graphics primitive (GP) is also received from the 3D-application or is determined from the geometrical information. The graphics primitive (GP) is sampled (RSS; RTS) in the direction indicated by the displacement vector to obtain input samples (RPi), and an one dimensional spatial filtering (ODF) is performed on the input samples (RPi) to obtain temporal prefiltering.

### FIELD OF THE INVENTION

The invention relates to a method of generating motion blur in a graphics system, and to a graphics computer system.

### BACKGROUND OF THE INVENTION

Usually, images are displayed on a display screen of a display apparatus in successive frames of lines. 3D objects displayed on the display screen which move with a large speed have a large frame to frame displacement. This is in particular the case for 3D games. The large displacement may lead to visual artifacts, often referred to as temporal aliasing. Temporal filtering, which adds blur to the images, alleviates these artifacts.

An expensive approach to alleviate temporal aliasing is to increase the frame rate such that the motions of the objects result in smaller frame to frame displacements. However, a high refresh rate requires an expensive display apparatus capable to display images with these high refresh rates.

Another approach is temporal super-sampling wherein the images are rendered multiple times within the frame display time interval. The rendered images are averaged and then displayed. This approach requires the 3D application to send the geometry for several instances within the frame to frame interval which requires a very powerful processing.

A cost effective solution is to average a present image during the present frame with the previous displayed image of the preceding frame. This approach provides an approximation of motion blur only, it does not provide a satisfactory quality of the images.

U.S. Pat. No. 6,426,755 discloses a graphics system and method for performing blur effects. In one embodiment, the system comprises a graphics processor, a sample buffer, and a sample-to-pixel calculation unit. The graphics processor is configured to render a plurality of samples based on a set of received three-dimensional graphics data. The processor is also configured to generate sample tags for the samples, wherein the sample tags are indicative of whether or not the samples are to be blurred. The super-sampled sample buffer receives and stores the samples from the graphics processor. The sample-to-pixel calculation unit receives and filters the samples from the super-sampled sample buffer to generate output pixels which form an image on a display device. The sample-to-pixel calculation units are configured to select the filter attributes used to filter the samples into output pixels based on the sample tags.

### SUMMARY OF THE INVENTION

It is an object of the invention to add the blur during a rasterization operation with a one-dimensional filter.

A first aspect of the invention provides a method of generating motion blur in a graphics system as claimed in claim 1. A second aspect of the invention provides a computer graphics system as claimed in claim 14. Advantageous embodiments are defined in the dependent claims.

In the method of generating motion blur in a graphics system in accordance with the first aspect of the invention, geometrical information defining a shape of a graphics primitive is received, this geometrical information may be the three-dimensional graphics data referred to in U.S. Pat. No. 6,426,755. It is also possible to use two-dimensional graphics data which is supplied by an application in a system which has less processing recourses. The method uses displacement information determining a displacement vector defining a direction of motion of the graphics primitive to sample the graphics primitive in the direction of the motion to obtain input samples. A one dimensional spatial filtering of the input samples provides the temporal filtering. In this manner a high quality blur is obtained without requiring complex processing and filtering.

A simple one dimensional filter is used without requiring redundant calculations. In contrast, the post-processing of U.S. Pat. No. 6,426,755 has to calculate a two-dimensional filter with a per pixel varying direction and amount of filtering. The approach in accordance with the invention has the advantage that sufficient motion blur is introduced in an effective manner. It is not required to increase the frame rate, nor to increase the temporal sample rate, the quality of the images is better than obtained by the prior art averaging.

A further advantage is that this approach can be implemented in the well known inverse texture mapping approach as claimed in claim 6, and in the forward texture mapping approach as claimed in claim 7. The known inverse mapping approach and the forward texture mapping approach as such will be elucidated in more detail with respect to FIGS. 2 and 4.

In an embodiment in accordance with the invention as defined in claim 2, the footprint of the one-dimensional filter varies with the magnitude of the displacement vector and thus with the motion. This has the advantage that the amount of blur introduced is correlated with the amount of displacement of a graphics primitive. If a low amount of movement is present, only a low amount of blur is introduced and a high amount of sharpness is preserved. If a high amount of movement is present, a high amount of blur is introduced to suppress the temporal aliasing artifacts. Thus, an optimal amount of blur is provided. It is easy to vary the amount of filtering because a one-dimensional filter is required only.

In an embodiment in accordance with the invention as defined in claim 3, the displacement vector is supplied by the 2D (two-dimensional) or 3D (three-dimensional) application which, for example, is a 3D game. This has the advantage that the programmers of the 2D or 3D application have full control over the displacement vector and thus can steer the amount of blur introduced.

In an embodiment in accordance with the invention as defined in claim 4, the 2D or 3D application provides information which defines the position and the orientation of the graphics primitives during a previous frame. The method of generating motion blur in accordance with an embodiment of the invention determines the displacement vector of the graphics primitives by comparing the position and the orientation of the graphics primitives in the present frame with the position and the orientation of the graphics primitives of the previous frame. This has the advantage that the displacement vectors do not have to be calculated by the 3D application in software, but instead the geometry acceleration hardware can be used for determining the displacement vectors.

In an embodiment in accordance with the invention as defined in claim 5, the buffering of the position and the orientation of the graphics primitives during the previous frame is performed by the method of generating motion blur in accordance with the invention. This has the advantage that a standard 3D application can be used, the displacement vectors are completely determined by the method of generating motion blur in accordance with the invention.

In an embodiment in accordance with the invention as defined in claim 6, the method of generating motion blur is implemented in the well known inverse texture mapping approach.

The intensities of the pixels present in the screen space define the displayed image on the screen. Usually, the pixels are actually positioned (in a matrix display) or thought to be positioned (in a CRT) in an orthogonal matrix indicated by an orthogonal x and y coordinate system. In the embodiment in accordance with the invention as defined in claim 6, the x and y coordinate system is rotated such that the screen displacement vector in the screen space occurs in the direction of the x-axis. Therefore, the sampling is performed in the screen space in the direction of the screen displacement vector. The graphics primitive in the screen space is the real world graphics primitive mapped (also referred to as projected) to the rotated screen space. Usually, the graphics primitive is a polygon. The screen displacement vector is the displacement vector of the eye space graphics primitive mapped to the screen space. The eye space graphics primitive is also referred to as the real world graphics primitive, which does not indicate that a physical object is meant, also synthetic objects are covered. The sampling provides coordinates of the resampled pixels which are used as input samples for the inverse texture mapping, instead of the coordinates of the pixels in the non-rotated coordinate system.

Then, the well known inverse texture mapping is applied. A blurring-filter which has a footprint in the rotated coordinate system, is allocated to the pixels. The pixels within the footprint will be filtered in accordance with the blurring-filter amplitude characteristics. The footprint in the screen space is mapped to the texture space and called the mapped footprint. Also the polygon in the screen space is mapped to the texture space and called the mapped polygon. The texture space comprises the textures which should be displayed on the surface of the polygon. These textures are defined by texel intensities stored in a texture memory. Thus, the textures are appearance information which defines an appearance of the graphics primitive by defining texel intensities in a texture space.

The texels both falling within the mapped footprint and within the mapped polygon are determined, the mapped blurring-filter is used to weight the texel intensities of these texels to obtain the intensities of the pixels in the rotated coordinate system (thus, the intensities of the resampled pixels instead of the intensities of the pixels in the well known inverse texture mapping wherein the coordinate system is not rotated).

The one-dimensional filtering averages the intensities of the pixels in the rotated coordinate system to obtain averaged intensities. A resampler resamples the averaged pixel intensities of the resampled pixels to obtain the intensities of the pixels in the original non-rotated coordinate system from the averaged intensities.

In an embodiment in accordance with the invention as defined in claim 7, the method of generating motion blur is implemented in the forward texture mapping approach.

In the texture space the texel intensities of the graphics primitive in the texture space are resampled in the direction of a texture displacement vector to obtain resampled texels (RTi). The texel displacement vector is the real world displacement vector mapped to the texel space. The texel intensities, which are stored in a texture memory, are interpolated to obtain the intensities of the resampled texels. The one-dimensional spatial filtering averages the intensities of the resampled texels in accordance with a weighting function to obtain filtered texels. The filtered texels of the graphics primitive are mapped to the screen space to obtain mapped texels. The intensity contributions of a mapped texel to all the pixels of which a corresponding pre-filter footprint of a pre-filter covers the mapped texel is determined. The contribution of a mapped texel to a particular pixel depends on the characteristic of the pre-filter. For each pixel, the intensity contributions of the mapped texels are summed to obtain the intensity of each one of the pixels.

Thus, said in other words, the coordinates of texels within the polygon in texture space are mapped to the screen space, and a contribution from a mapped texel to all the pixels of which the corresponding pre-filter footprint covers this texel is determined in accordance with the filter characteristic for this texel, and finally all the contribution of the texels are summed for each pixel to obtain the pixel intensity.

In an embodiment in accordance with the invention as defined in claim 8, the displacement vector of the graphics primitive is determined as an average of the displacement vector of vertices of the graphics primitive. This has the advantage that only a single displacement vector for each polygon is required, which displacement vector can be determined in an easy manner. It suffices if the directions of the displacement vectors of the vertices is averaged. The magnitude of the displacement vector may be interpolated over the polygon.

In an embodiment in accordance with the invention as defined in claim 9, the intensities of the resampled pixels are distributed, in the screen space, in a direction of the displacement vector in the screen space over a distance determined by a magnitude of the displacement vector to obtain distributed intensities. The overlapping distributed intensities of different pixels are averaged to obtain a piece-wise constant signal which is the averaged intensity in screen space. This has the advantage that a shutter behavior of a camera is resembled, thus providing a very acceptable motion blur.

In an embodiment in accordance with the invention as defined in claim 10, the the intensities of the resampled texels are distributed, in the texture space, in a direction of the displacement vector in the texture space over a distance determined by a magnitude of the displacement vector to obtain distributed intensities. The overlapping distributed intensities of different resampled texels are averaged to obtain a piece-wise constant signal which is the averaged intensity in the texture space (also referred to as filtered texel). This has the advantage that a shutter behavior of a camera is resembled, thus providing a very acceptable motion blur.

In an embodiment in accordance with the invention as defined in claim 11, the one-dimensional spatial filtering applies different weighted averaging fimctions during one or more frame-to-frame intervals. This has the advantage that although in each frame an efficient one-dimensional filter is performed, a higher-order temporal filtering is obtained. At the rendering of the frame, only partial intensities of the pixels are calculated which have to be stored. The pixel intensities of n successive frames have to be accumulated to obtain the correct pixel intensities. In this case, n is the width of the temporal filter. The higher-order filtering provides less aliasing with a same amount of blur, or, equivalently, a reduced blur with the same amount of temporal aliasing.

In an embodiment in accordance with the invention as defined in claim 12, the distance over which the resampled pixels or the resampled texels are distributed is rounded to a multiple of the distance between resampled texels. This avoids a doubling of the number of resampled texels during the accumulation of the distributed intensities of the texels.

These and other aspects of the invention are apparent from and will be elucidated with reference to the embodiments described hereinafter.

In an embodiment in accordance to the invention as defined in claim 13, the motion vector now is subdivided in segments. In the embodiment in accordance with the invention as defined in claim 10, the intensities of the resampled texels are distributed, in the texture space, in a direction of the displacement vector in the texture space over a distance determined by a magnitude of the displacement vector to obtain distributed intensities. The overlapping distributed intensities of different resampled texels are averaged to obtain a motion blurred texture which is a piece-wise constant signal. Wherein the displacement vector is valid for a complete frame, and thus the motion blur is introduced in images rendered at a frame rate.

The motion vector of the embodiment defined in claim 13 is subdivided in segments which are associated with sub-displacement vectors, one for each segment, and thus the motion blur is introduced in images rendered at a higher frame rate determined by the number of segments in a frame period. In fact a frame rate up-conversion is reached. Now, the frame period is sub-divided in a number of sub-frames which is equal to the number of segments. Thus, instead of the single frame, several sub-frames are rendered on the basis of a single sampling of the 3D model including the displacement information covered by the motion vector. The blur size of objects within these sub-frames may be shortened according to the frame rate up conversion.

### BRIEF DESCRIPTION OF THE DRAWINGS

In the drawings:

FIG. 1 elucidates a display of a real world 3D object on a display screen,

FIG. 2 elucidates the known inverse texture mapping,

FIG. 3 shows a block diagram of a circuit for performing the known inverse texture mapping,

FIG. 4 elucidates the forward texture mapping,

FIG. 5 shows a block diagram of a circuit for performing the forward texture mapping,

FIG. 6 shows a block diagram of a circuit in accordance with an embodiment of the invention,

FIG. 7 elucidates the sampling in the direction of the displacement vector in the screen space,

FIG. 8 shows a block diagram of a circuit in accordance with an embodiment of the invention comprising the inverse texture mapping,

FIG. 9 elucidates the sampling in the direction of the displacement vector in the texture space,

FIG. 10 shows a block diagram of a circuit in accordance with an embodiment of the invention comprising forward texture mapping,

FIG. 11 shows an embodiment of a blurring filter with a footprint,

FIG. 12 shows the determination of a displacement vector of a polygon based on the displacement vectors of vertices of the polygon,

FIG. 13 shows the temporal pre-filtering using stretched pixels in accordance with an embodiment of the invention.

FIG. 14 shows the temporal pre-filtering using stretched texels in accordance with an embodiment of the invention,

FIG. 15 shows the approximation of motion blur of a camera by using the stretched texels in accordance with an embodiment of the invention,

FIGS. 16 show schematically that it is possible to sub-divide the frame period in sub-frame periods, and

FIG. 17 shows a block diagram of a circuit in accordance with an embodiment of the invention comprising the forward texture mapping combined with frame rate up-conversion.

### DETAILED DESCRIPTION OF THE PREFERRED EMBODIMENT

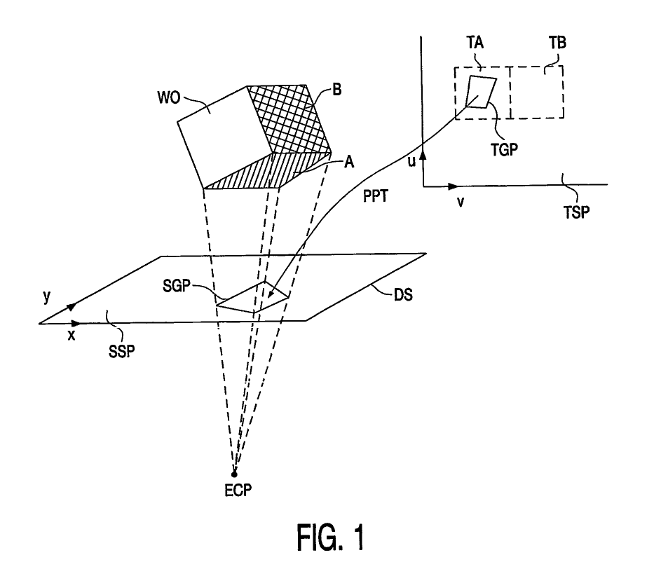

FIG. 1 elucidates a display of a real world 3D object on a display screen. A real world object WO, which may be a three-dimensional object such as the cube shown, is projected on a two-dimensional display screen DS. The three-dimensional object WO has a surface structure or texture which defines the appearance of the three-dimensional object WO. In FIG. 1 the polygon A has a texture TA and the polygon B has a texture TB. The polygons A and B are with a more general term also referred to as the real world graphics primitives.

The projection of the real world object WO is obtained by defining an eye or camera position ECP with respect to the screen DS. In FIG. 1 is shown how the polygon SGP corresponding to the polygon A is projected on the screen DS. The polygon SGP in the screen space SSP defined by the coordinates X and Y is also referred to as a graphics primitive instead of the graphics primitive in the screen space. Thus, with graphics primitive is indicated the polygon A in the eye space, or the polypon SGP in the screen space, or the polygon TGP in the texture space, it is clear from the context which graphics primitive is meant. It is only the geometry of the polygon A which is used to determine the geometry of the polygon SGP. Usually, it suffices to know the vertices of the polygon A to determine the vertices of the polygon SGP.

The texture TA of the polygon A is not directly projected from the real world into the screen space SSP. The different textures of the real world object WO are stored in a texture map or texture space TSP defined by the coordinates U and V. For example, FIG. 1 shows that the polygon A has a texture TA which is available in the texture space TSP in the area indicated by TA, while the polygon B has another texture TB which is available in the texture space TSP in the area indicated by TB. The polygon A is projected on the texture space TA such that a polygon TGP occurs such that when the texture present within the polygon TGP is projected on the polygon A the texture of the real world object WO is obtained or at least resembled as much as possible. A perspective transformation PPT between the texture space TSP and the screen space SSP projects the texture of the polygon TGP on the corresponding polygon SGP. This process is also referred to as texture mapping. Usually, the textures are not all present in a global texture space, but every texture defines its own texture space.

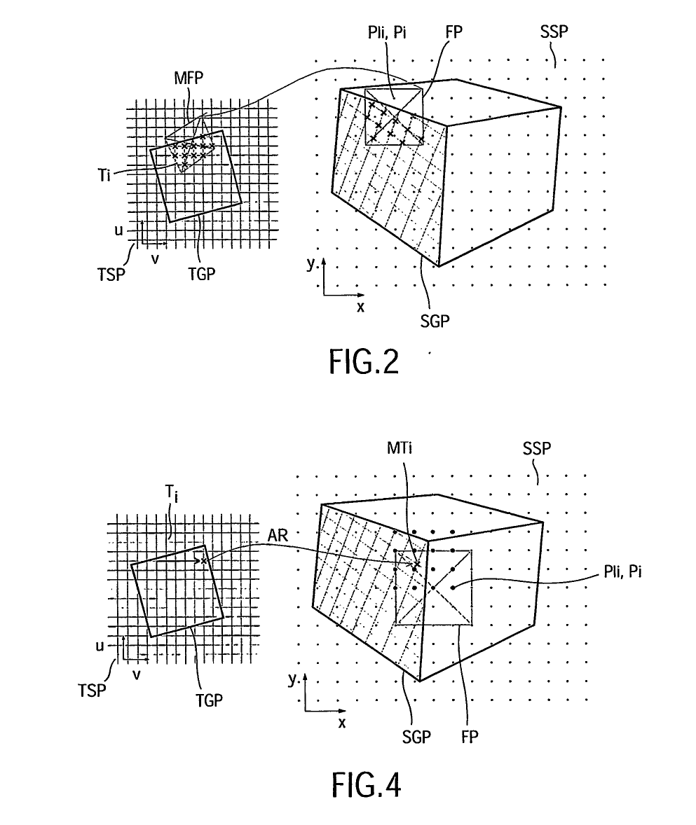

FIG. 2 elucidates the known inverse texture mapping. FIG. 2 shows the polygon SGP in the screen space SSP and the polygon TGP in the texture space TSP. To facilitate the elucidation, it is assumed that both the polygon SGP and the polygon TGP correspond to the polygon A of the real world object WO of FIG. 1.

The intensities PIi of the pixels Pi present in the screen space SSP define the image displayed. Usually, the pixels Pi are actually positioned (in a matrix display) or thought to be positioned (in a CRT) in an orthogonal matrix of positions. In FIG. 2 only a limited number of the pixels Pi is indicated by the dots. The polygon SGP is shown in the screen space SSP to indicate which pixels Pi are positioned within the polygon SGP.

The texels or texel intensities Ti in the texture space TSP are indicated by the intersections of the horizontal and vertical lines. These texels Ti which usually are stored in a memory called texture map define the texture. It is assumed that the part of the texel map or texture space TSP shown corresponds to the texture TA shown in FIG. 1. The polygon TGP is shown in the texture space TSP to indicate which texels Ti are positioned within the polygon TGP.

The well known inverse texture mapping comprises the steps elucidated in the now following. A bluring-filter which has a footprint FP is shown in the screen space SSP and has to operate on the pixels Pi to perform a weighted averaging operation required to obtain the blurring. This footprint FP in the screen space SSP is mapped to the texture space TSP and called the mapped footprint MFP. The polygon TGP which may be obtained by mapping the polygon SGP from the screen space SSP to the texture space TSP is also called the mapped polygon. The texture space TSP comprises the textures TA, TB (see FIG. 1) which should be displayed on the surface of the polygon SGP. As described above, these textures TA, TB are defined by texel intensities Ti stored in a texel memory. Thus, the textures TA, TB are appearance information which define an appearance of the graphics primitive SGP by defining texel intensities Ti in a texture space TSP.

The texels Ti both falling within the mapped footprint MFP and within the mapped polygon TGP are determined. These texels Ti are indicated by the crosses. The mapped blurring-filter MFP is used to weight the texel intensities Ti of these texels Ti to obtain the intensities of the pixels Pi.

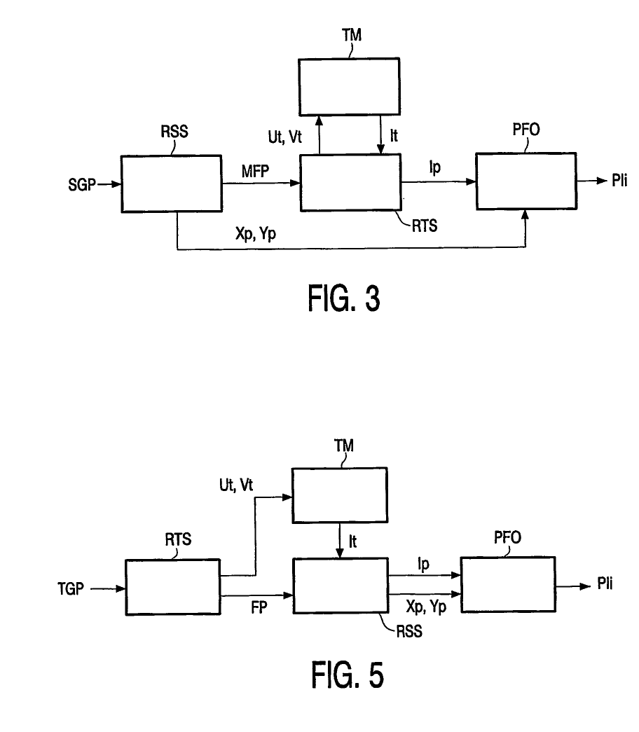

FIG. 3 shows a block diagram of a circuit for performing the known inverse texture mapping. The circuit comprises a rasterizer RSS which operates in the screen space SSP, a resampler RTS in the texture space TSP, a texture memory TM and a pixel fragment processing circuit PFO. Ut, Vt is the texture coordinate of a texel Ti with index t, Xp, Yp is the screen coordinate of a pixel with index p, It is the color of the texel Ti with index t, and Ip is the filtered color of pixel Pi with index p.

The rasterizer RSS rasterizes the polygon SGP in the screen space SSP. For every pixel Pi traversed, its blurring filter footprint FP is mapped to the texture space TSP. The texels Ti within the mapped footprint MFP and within the mapped polygon TGP are determined and weighted according to a mapped profile of the blurring filter. The color of the pixels Pi is computed using the mapped blurring filter in the texture space TSP.

Thus, the rasterizer RSS receives the polygons SGP in the screen space SSP to supply the mapped blurring filter footprint MFP and the coordinates of the pixels Pi. A resampler in the texture space RTS receives the mapped blurring filter footprint MFP and information on the position of the polygon TGP to determine which texels Ti are within the mapped footprint MFP and within the polygon TGP. The intensities of the texels Ti determined in this manner are retrieved from the texture memory TM. The blurring filter filters the relevant intensities of the texels Ti determined in this manner to supply the filtered color Ip of the pixel Pi.

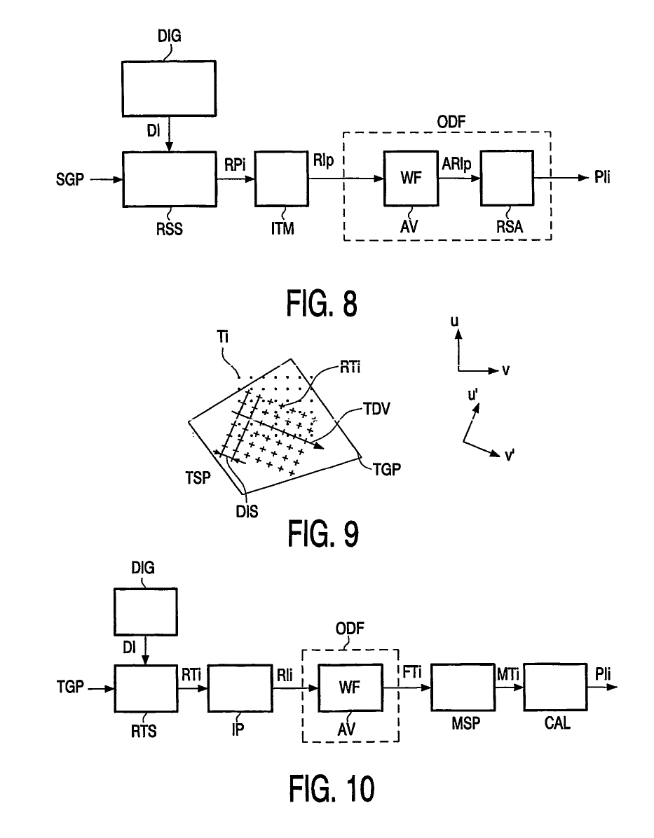

The pixel fragment processing circuit PFO blends the pixel intensities PIi of overlapping polygons due to the blurring. The pixel fragment processing circuit PFO may comprise a pixel fragment composition unit, also commonly referred to as A-buffer, which contains a fragment buffer. Such a pixel fragment processing circuit PFO may be provided at the output of the circuits shown in FIGS. 8, 10, 17. Commonly, a fragment buffer is used to minimize edge anti-alising based on geometric information on the overlap of an area (often a square) associated to a pixel with the polygon. Often a mask is used on a super-sample grid which enables a quantized approximation of the geometric information. This geometric information is an embodiment of what is called “contribution factor” of a pixel. For the motion blur application, the contribution value of the pixels of a moving object is dependent on the motion speed and is filtered blurry in the same manner as the color channels. The pixel fragment composition unit PFO will blend these pixel fragments accordingly to their contribution factor until the sum of the contribution factors reaches 100%, or no pixel fragments are available anymore, thereby generating the effect of translucent pixels of moving objects.

To be able to implement the above proces, pixel fragments are required in depth (Z-value) sorted order. Because polygons can be delivered in random depth order, the pixel fragments per pixel location are stored in depth sorted order in a pixel fragment buffer. However, the in the fragment buffer stored contribution factor is now not based on the geometric coverage per pixel. Instead, the contribution factor, which depends on the motion speed and which is filtered blurry in the same manner as the color channels, is stored. The pixel fragment composition algorithm comprises two stages: insertion of pixel fragments in the fragment buffer and composition of pixel fragments from the fragment buffer. To prevent overflow during the insertion phase, fragments which are closests in their depht values may be merged. After all the polygons of the scene are rendered, the composition phase composes fragments per pixel position in a front to back order. The final pixel color is obtained when the sum of the contribution factors of all added fragments is one or more, or when all pixel fragments have been processed.

FIG. 4 elucidates forward texture mapping. FIG. 4 shows the polygon SGP in the screen space SSP and the polygon TGP in the texture space TSP. To facilitate the elucidation, it is assumed that both the polygon SGP and the polygon TGP correspond to the polygon A of the real world object WO of FIG. 1.

The intensities PIi of the pixels Pi present in the screen space SSP define the image displayed. The pixels Pi are indicated by the dots. The polygon SGP is shown in the screen space SSP to indicate which pixels Pi are positioned within the polygon SGP. The pixel actually indicated by Pi is positioned outside the polygon SGP. With each pixel Pi a footprint FP of a blur filter is associated.

The texels or texel intensities Ti in the texture space TSP are indicated by the interstices of the horizontal and vertical lines. Again, these texels Ti which usually are stored in a memory called texture map define the texture. It is assumed that the part of the texel map or texure space TSP shown corresponds to the texture TA shown in FIG. 1. The polygon TGP is shown in the texture space TSP to indicate which texels Ti are positioned within the polygon TGP.

The coordinates of the texels Ti within the polygon TGP are mapped (resampled) to the screen space SSP. In FIG. 4, this mapping (indicated by the arrow AR from the texture space TSP to the screen space SSP) of a texel Ti (indicated by a cross in the texture space) to the screen space SSP provides mapped texels MTi (indicated by the cross in the screen space SSP, which cross may be positioned in-between pixel positions indicated by the dots) in the screen space SSP. A contribution of the mapped texel MTi to all the pixels Pi which have a footprint FP of the blur filter which encompases the mapped texel MTi is determined in accordance with the filter characteristic of the blur filter. All the contributions of the mapped texels MTi to the pixels Pi are summed to obtain the intensities PIi of the pixels Pi.

In the forward texture mapping, the resampling from the colors of the texel Ti to the colors of the pixels Pi occurs in the screen space SSP, and thus is input sample driven. Compared to the inverse texture mapping, it is easier to determine which texels Ti contribute to a particular pixel Pi. Only the mapped texels MTi which are within a footprint FP of the blurring filter for a particular pixel Pi will contribute to the intensity or color of this particular pixel Pi. Further, there is no need to transform the blurring filter from the screen space SSP to the texel space TSP.

FIG. 5 shows a block diagram of a circuit for performing the forward texture mapping. The circuit comprises a rasterizer RTS which operates in the texture space TSP, a resampler RSS in the screen space SSP, a texture memory TM and a pixel fragment processing circuit PFO. Ut, Vt is the texture coordinate of a texel Ti with index, Xp, Yp is the screen coordinate of a pixel with index p, It is the color of the texel Ti with index t, and Ip is the filtered color of pixel Pi with index p.

The rasterizer RTS rasterizers the polygon TGP in the texture space TSP. For every texel Ti which is within the polygon TGP, the resampler in the screen space RSS maps the texel Ti to a mapped texel MTi in the screen space SSP. Further, the resampler RSS determines the contribution of a mapped texel MTi to all the pixels Pi of which the associated footprint FP of the blurring filter encompasses this mapped texel MTi. Finally, the resampler RSS sums the intensity contributions of all mapped texels MTi to the pixels Pi to obtain the intensities PIi of the pixels Pi.

The pixel fragment processing circuit PFO shown in FIG. 5 has been elucidated in detail with respect to FIG. 3.

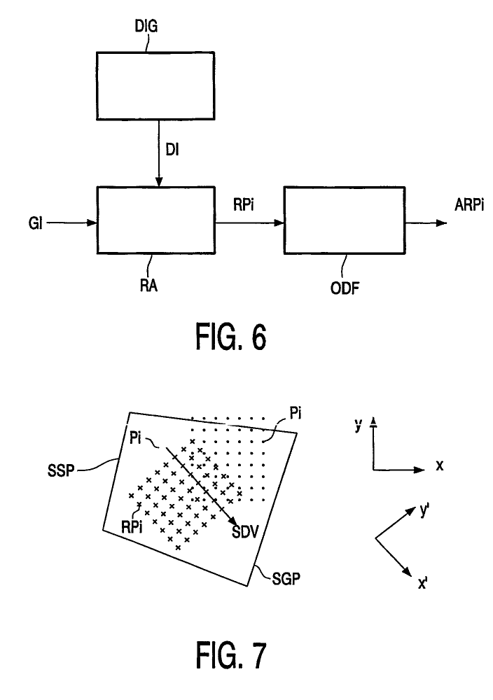

FIG. 6 shows a block diagram of a circuit in accordance with an embodiment of the invention. This motion blur generating circuit comprises a rasterizer RA, a displacement providing circuit DIG, and a one-dimensional filter ODF.

The rasterizer RA receives both geometrical information GI which defines the shape of a graphics primitive SGP or TGP and displacement information DI which determines a displacement vector defining a direction of the motion of the graphics primitive SGP or TGP. The rasterizer RA samples the graphics primitive SGP or TGP in the direction of the displacement vector to obtain samples RPi. The one-dimensional filter ODF provides a temporal pre-filtering by filtering the samples RPi to obtain averaged intensities ARPi.

The rasterizer RA may operate in the screen space SSP or in the texture space TSP. If the rasterizer RA operates in the screen space SSP, the graphics primitive SGP or TGP may be the polygon SGP, and the samples RPi are based on the pixels Pi. If the rasterizer RA operates in the texture space TSP, the graphics primitive SGP or TGP may be the polygon TGP, and the samples RPi are based on the texels Ti.

The use of a rasterizer RA in the screen space SSP is elucidated with respect to FIG. 7 and with respect to its combination with the inverse texture mapping (see FIG. 8).

The use of a rasterizer RA in the texture space TSP is elucidated with respect to FIG. 9 and with respect to its combination with the forward texture mapping (see FIG. 10).

FIG. 7 elucidates the sampling in the direction of the displacement vector in the screen space. The real world object WO moves in a certain direction. This movement of the complete object WO causes the graphics primitives (the polygons A and B) to move also. The movement of the polygon A can be indicated in the screen space SSP by the displacement vector SDV of the polygon SGP. Other polygons of the real world object WO may have other displacement vectors. The intensities PIi of the pixels Pi are resampled such that resampled pixels RPi are determined which are positioned in a rectangular grid of which one direction coincides with the direction of the displacement vector SDV. The pixels Pi are indicated by dots, the resampled pixels RPi are indicated by crosses. Only a few pixels Pi and resampled pixels RPi are shown.

The pixels Pi of which the intensities PIi determine the image displayed are positioned in the orthogonal coordinate space defined by the orthogonal axis x and y. The resampled pixels RPi are positioned in the orthogonal coordinate space defined by the orthogonal axis x′ and y′.

FIG. 8 shows a block diagram of a circuit in accordance with an embodiment of the invention comprising the inverse texture mapping.

The sampler RSS, which is the sampler RA shown in FIG. 6 which samples in the screen space SSP, samples within a polygon SGP in the direction of the displacement vector SDV of this polygon SGP to obtain resampled pixels RPi. Therefore, the sampler RSS receives the geometry of the polygon SGP and the displacement information DI from the displacement providing circuit DIG. The displacement information DI may comprise the direction in which the displacement occurs and the amount of displacement and thus may be the displacement vector SDV. The displacement vector SDV may be supplied by the 3D application, or may be determined by the displacement providing circuit DIG from the position of the polygon A in successive frames. The resampled pixels RPi occur in an equidistant orthogonal coordinate space of positions which are aligned with the displacement vector SDV. Or said differently, the coordinate system x, y in the screen space is rotated such that a rotated coordinate system x′, y′ is obtained of which the x′ axis is aligned with the displacement vector.

The inverse texture mapper ITM receives the resampled pixels RPi to supply intensities RIp. The inverse texture mapper ITM operates in the same manner as the well known inverse texture mapping as elucidated with respect to FIGS. 2 and 3. But, instead of the coordinates of the pixels Pi, the coordinates of the resampled pixels RPi are used. Thus, the footprint FP of the filter in the screen space is now defined in the coordinate system which is aligned with the screen displacement vector. This footprint is mapped to the texture space where the texels within both this mapped footprint and within the polygon ore weighted according to the mapped filter characteristics to obtain the intensity of the resampled pixel RIp to which the footprint belongs.

The one-dimensional filter ODF comprises an averager AV and a resampler RSA. The averager AV averages the intensities RIp to obtain averaged intensities ARIp. The averging is performed in accordance with a weighting function WF. The resampler RSA resamples the averaged intensities ARIp to obtain the intensities PIi of the pixels Pi.

FIG. 9 elucidates the sampling in the direction of the displacement vector in the texture space. The real world object WO moves in a certain direction. This movement of the complete object WO causes the graphics primitives (the polygons A and B) to move also. The movement of the polygon A can be indicated in the texture space TSP by the displacement vector TDV of the polygon TGP. Other polygons of the real world object WO may have other displacement vectors. The intensities of the texels Ti are resampled such that resampled texels RTi are obtained which are positioned in a matrix of which one direction coincedents with the direction of the displacement vector TDV. The texels Ti are indicated by dots, the resampled texels RTi are indicated by crosses. Only a few texels Ti and resampled texels RTi are shown.

The texels Ti of which the intensities determine the texture displayed are positioned in the orthogonal coordinate space defined by the orthogonal axis U and V. The resampled texels RTi are positioned in the orthogonal coordinate space defined by the orthogonal axis U′ and V′. A distance DIS between two samples (texels Ti) in the texture space is indicated by DIS.

FIG. 10 shows a block diagram of a circuit in accordance with an embodiment of the invention comprising the forward texture mapping.

The sampler RTS, which is the sampler RA shown in FIG. 6 which samples in the texture space TSP, samples within a polygon TGP in the direction of the displacement vector TDV of this polygon TGP to obtain the resampled texels RTi. Therefore, the sampler RTS receives the geometry of the polygon TGP and the displacement information DI from the displacement providing circuit DIG. The displacement information DI may comprise the direction in which the displacement occurs and the amount of displacement and thus may be the displacement vector TDV. The displacement vector TDV may be supplied by the 3D application, or may be determined by the displacement providing circuit DIG from the position of the polygon A in successive frames.

The interpolator IP interpolates the intensities of the texels Ti to obtain the intensities RIi of the resampled texels RTi.

The one-dimensional filtering ODF comprises an averager AV which averages the intensities RIi in accordance with a weighting function WF to obtain filtered resampled texels FTi to which is also referred as filtered texels FTi.

The mapper MSP maps the filtered texels FTi within the polygon TGP (in more general also referred to as the graphics prinmitive) to the screen space SSP to obtain the mapped texels MTi (see FIG. 4).

The calculator CAL determines the intensity contributions of each of the mapped texels MTi to each of the pixels Pi of which a corresponding pre-filter footprint FP of a pre-filter PRF (see FIG. 11) covers one of the mapped texels MTi. The intensity contributions depend on the characteristics of the pre-filter PRF. For example, if the pre-filter has a cubic amplitude characteristic and if a mapped texel MTi is very near to a pixel Pi, the contribution of this mapped texel MTi to the intensity of the pixel Pi is relatively large. If the mapped texel is at the border of the footprint FP of the prefilter which is centered at a pixel Pi, the contribution of the mapped texel MTi is relatively small. If the mapped texel MTi is not within the footprint FP of the prefilter of a particular pixel Pi, this mapped texel MTi will not contribute to the intensity of the particular pixel Pi.

The calculator CAL sums all the contribution of the different mapped texels MTi to the pixels Pi to obtain the intensities PIi of the pixels Pi. The intensity PIi of a particular pixel Pi only depends on the intensities of the mapped texels MTi within the footprint FP belonging to this particular pixel Pi and the amplitude characteristic of the prefilter. Thus for a particular pixel Pi only the contributions of the mapped texels MTi within the footprint FP belonging to this particular pixel Pi need to be summed. This calculator CAL shown in FIG. 10, and the resampler RSA shown in FIG. 8 are in fact identical and may also be referred to as the screen space resampler.

FIG. 11 shows an embodiment of a blurring filter with a footprint. The blurring filter (also referred to as pre-filter) PRF, which in FIG. 11 filters in the screen space SSP, has a footprint FP. The footprint FP is the area of the filter PRF in the x an/or y direction in which a mapped texel MTi contributes to a pixel Pi. The filter PRF is shown for a pixel Pi at a position Xp in the screen space SSP. In the example of the filter PRF shown, the footprint FP is four pixel distances wide and covers in the x-direction the positions Xp−2, Xp−1, Xp, Xp+1, Xp+2. A mapped texel MTi which is mapped at the position Xm will contribute to the pixel Pi at the position Xp with the intensity of the mapped texel MTi multiplied with the filter value CO1.

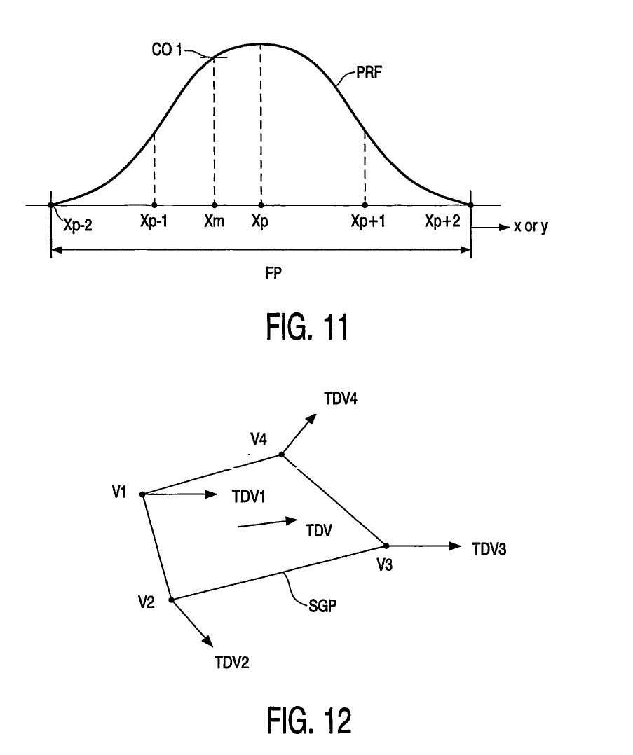

FIG. 12 shows the determination of a displacement vector of a polygon based on the displacement vectors of vertices of the polygon. The polygon SGP in the screen space SSP has vertices Vl, V2, V3, V4 to which the displacement vectors TDVI, TDV2, TDV3, TDV4, respectively, are associated. Preferably, the displacement vector TDV for all the pixels Pi with the polygon SGP is the average of the displacement vectors TDV1, TDV2, TDV3, TDV4. Thus, the displacement vectors TDV1, TDV2, TDV3, TDV4 are vectorially added to obtain both the direction and the amplitude (after division by the number of vertices) of the displacement vector TDV.

More complex approaches are possible, for example, if the displacement vectors TDV1, TDV2, TDV3, TDV4 are largely different, the polygon may be divided in smaller polygons.

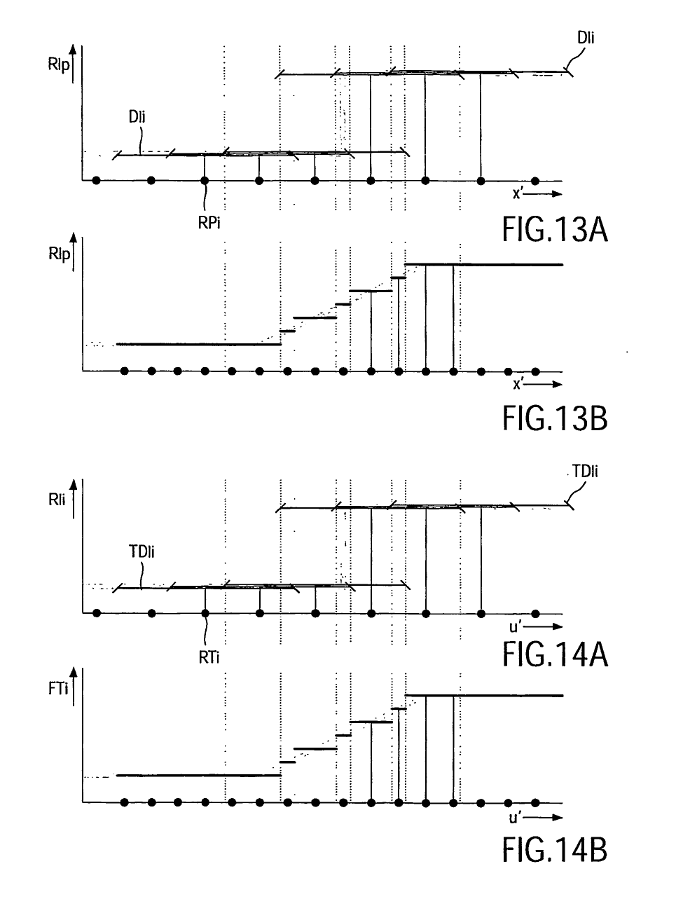

FIG. 13 shows the temporal pre-filtering using stretched pixels in accordance with an embodiment of the invention. The one-dimensional filter ODF is performed by first distributing the intensities RIp of the resampled pixels RPi in the direction of the displacement vector SDV. The distribution of the intensity RIp is performed in an area around the associated resampled pixel RPi such that the local intensity RIp is spread out over this area. The dimensions of the area are determined by the magnitude of the displacement vector SDV. This spreading out of the intensity RIp is also referred to as stretching the pixels Pi. As an example only, FIG. 13 shows a motion displacement which is 3.25 times the distance between two adjacent resampled pixels RPi. The pixel stretching in the x′ direction (see FIG. 7) is elucidated.

In FIG. 13A, the intensities RIp of the resampled pixels RPi are distributed or stretched as indicated by the horizontal lines indicated by DIi. Each dot on the x′-axis indicates the position of a resampled pixel RPi. The lines DIi show that the intensity RIp of each of the resampled pixels RPi is distributed to cover another one of resampled pixels RPi both at the left hand side and at the right hand side of each of the resampled pixels RPi.

FIG. 13B shows the average of the overlapping distributed intensities DIi.

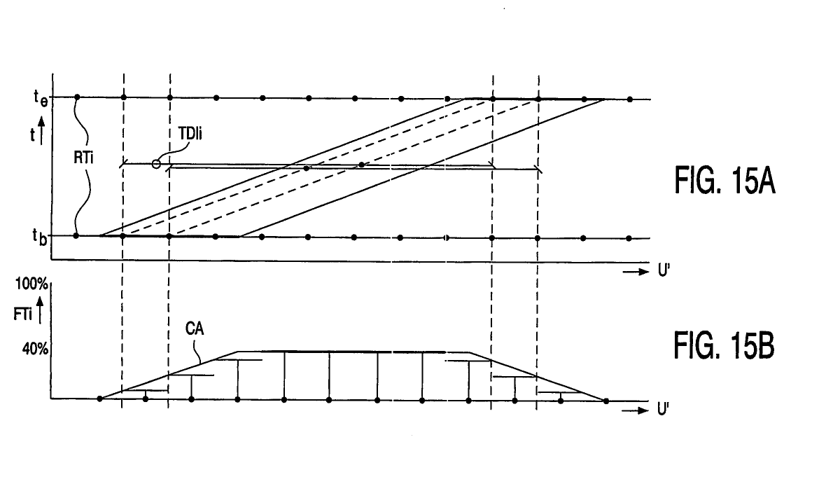

FIG. 14 shows the temporal pre-filtering using stretched texels in accordance with an embodiment of the invention. The one-dimensional filter ODF is performed by first distributing the intensities RIi of the resampled texels RTi in the direction of the displacement vector TDV. The distribution of the intensity RIi is performed in an area around the associated resampled texel RTi such that the local intensity RIi is spread out over this area. The dimensions of the area are determined by the magnitude of the displacement vector TDV. This spreading out of the intensity RIi is also referred to as stretching the resampled texels RTi. As an example only, FIG. 14 shows a motion displacement which is 3.25 times the distance between to adjacent resampled texels RTi. The texel stretching in the U′ direction (see FIG. 9) is elucidated.

In FIG. 14A, the intensities RIi of the resampled texels RTi are distributed or stretched as indicated by the horizontal lines indicated by TDIi, for clarity only a few of these lines are shown, and different lines have a small offset to be able to distinguish them from each other. Each dot on the U′-axis indicates the position of a resampled texel RTi. The lines TDIi show that the intensity RIi of each of the resampled texels RTi is distributed to cover another one of resampled texels RTi both at the left hand side and at the right hand side of each one of the resampled texels RTi.

FIG. 14B shows the average FTi of the overlapping distributed intensities TDIi.

The stretched texels are overlapping if the motion displacement during the frame sample interval is larger than the distance between two adjacent resampled texels RTi. The piece-wise constant signal FTi which is obtained by averaging the overlapping parts of the distributed intensities TDIi is a good approximation of the time-continue integration of a camera as will be explained with respect to FIG. 15. Thus, the result of the texel stretching is a blur which resembles the blur of a traditional camera. This blur is very acceptable to a viewer. If the stretched texels are not overlapping due to no or a small amount of motion, no motion blur is generated and a spatial box reconstruction is applied.

FIG. 14 illustrates the averaging of the overlapping parts of the distributed intensities DIi for a motion displacement of 3.25 times the mapped texel distances. The obtained piece-wise constant signal FTi is an approximation of an integrated signal. It is possible to view the piece-wise constant signal FTi as a box reconstruction of artificial samples that represent the averaged overlapping parts. The artificial samples depend on a varying number of overlapping stretched texels. In FIG. 14, either three or four stretched texels overlap. This can be avoided by restricting the edges of the stretched texels to the resampled or mapped texel positions RTi. Thus, a motion blur factor is used which is an integer multiple of the distance between resampled texels RTi.

FIG. 15 shows the approximation of motion blur of a camera by using the stretched texels in accordance with an embodiment of the invention. FIG. 15A shows a texel stretching of eight mapped texel distances. The line indicated by tb shows the positions of the resampled texels RTi in the U′ direction for a particular frame. The line indicated by te shows the positions of the resampled texels RTi in the U′ direction for a frame succeeding the particular frame. The distributed intensities RIi are indicated by the lines TDIi. The resulting piece-wise constant intensity FTi is shown in FIG. 15B. The solid lines indicated by CA show the motion blur introduced by a camera.

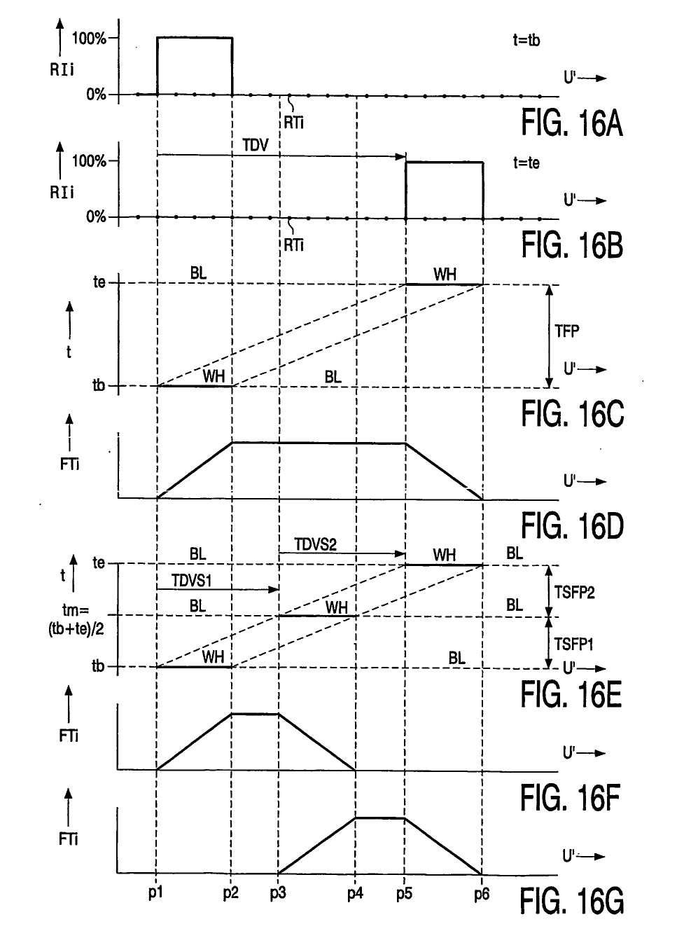

With respect to both FIGS. 13 and 14, the 3D application may provide the motion blur vectors per vertex. The motion blur vectors indicate the displacement of the vetrex from a previous 3D geometry sample instant tb to the current 3D sample instant te (see FIGS. 15 and 16. Alternatively, the 3D application may provide information which allows detenmining the motion blur vectors which are also referred to as the displacement vectors TDV. The footprint or the filter length of the one dimensional filter ODF is associated with the whole or a fraction of the shutter open (or exposure) interval of a normal movie camera. By varying the exposure time and thus the filter footprint, the number of resampled texels RTi which are within the filter footprint and thus the amount of averaging performed by the filter ODF is varied. In this manner it is possible to compromise between the amount of blur versus the amount of temporal aliasing. For example, to mimic a camera with an exposure time of one tenth of the frame period te-tb the footprint of the (spatial) filter ODF is related to this fraction of the frame period. In FIG. 15 the exposure time is equal to the frame period and thus the full displacement vector TDV between the two frames is used to obtain the motion blurred piece-wise constant intensity FTi.

FIGS. 16 show schematically that it is possible to sub-divide the frame period in sub-frame periods.

FIG. 16A shows the intensity RIi of the resampled texels RTi at the instant tb of a first frame. The resampled texels RTi extend in the direction of the movement U′ of the vertex and are indicated on the U′ axis with equidistant spaced dots. In this example, the intensity RIi of the resampled texels RTi is 100% from position p1 to p2, and 0% for other positions.

FIG. 16B shows the intensity RIi of the resampled texels RTi at the instant te of a second frame which immediately succeeds the first frame. The resampled texels RTi extend in the direction of the movement U′ of the vertex and are indicated on the U′ axis with equidistant dots. In this example, the intensity RIi of the resampled texels RTi is 100% from position p5 to p6, and 0% for other positions. Thus, from the first frame to the second frame, the texel intensities are moved from position p1 to position p5 as indicated by the displacement vector TDV.

FIG. 16C is a combined representation of FIGS. 16A and 16B. Now, the vertical axis represents the time while the intensity RIi of the resampled texels RTi is indicated by a thick non-dashed line WH if the intensity is 100% or by a dashed line BL if the intensity is 0%. The resampled texels RTi are not explicitly indicated from FIG. 16C onwards, but might occur at the same positions as shown in FIGS. 16A and 16B. The period of time between the occurrence of the first and the second frame is indicated by the frame period TFP, which more precisely is the frame repitition period. FIG. 16C is in fact similar to FIG. 15A.

FIG. 16D shows schematically the motion blurred texels FTi, in case of non-frame-rate-up conversion also referred to as the piece wise constant signal FTi. The same signal together with the more detailed piece wise constant signal FTi is shown in FIG. 15B. With respect to FIGS. 15 it is described how this piece wise constant signal FTi is obtained by averaging the “stretched” intensities RIi of the resampled texels RTi. The amount of stretching depends on the magnitude of the displacement vector TDV and the shutter open interval selected for the whole frame.

FIG. 16E is a same representation as FIG. 16C. Now, by way of example, the frame period TFP is sub-divided in two sub-frame periods TSFP1 and TSFP2. It is of course possible to sub-divide the frame period TFP in more than two sub-frame periods. The first sub-frame TSFP1 starts at tb and ends at tm=(tb+te)/2. The second sub-frame TSFP2 starts at tm and lasts until te.

It is assumed that the speed of movement is constant, thus the displacement vector TDV is now sub-divided in a first displacement vector TDVS1 and a second displacement vector TDVS2. The magnitude of each of these two sub-divided displacement vectors TDVS1, TDVS2 is half the magnitude of the displacement vector TDV. If the motion speed is not constant and/or the motion path is in different directions the two sub-divided displacement vectors TDVS1, TDVS2 may have different magnitudes and/or directions.

At an assumed linear movement, at the instant tb, the resampled texels RTi have the 100% intensity WH from the positions p1 to p2, at the instant tm, the resampled texels RTi have the 100% intensity WH from the positions p3 to p4, and at the instant te, the resampled texels RTi have the 100% intensity WH from the positions p5 to p6. At the other positions the intensity RIi is 0% as indicated by BL.

FIG. 16F shows the filtered texels FTi for the first sub-frame TSFP1. The one-dimensional filtering ODF is again performed by averaging the “stretched” intensities RIi of the resampled texels RTi as elucidated with respect to FIGS. 16C and 16D, wherein now the amount of stretching depends on the magnitude of the sub-displacement vector TDVS1. Again, as in FIG. 16D only the envelope of the piece wise constant signal FTi is shown.

FIG. 16G shows the filtered texels FTi for the second sub-frame TSFP1. The one-dimensional filtering ODF is again performed by averaging the “stretched” intensities RIi of the resampled texels RTi as elucidated with respect to FIGS. 16C and 16D, wherein now the amount of stretching depends on the magnitude of the sub-displacement vector TDVS2. Again, as in FIG. 16D only the envelope of the piece wise constant signal FTi is shown.

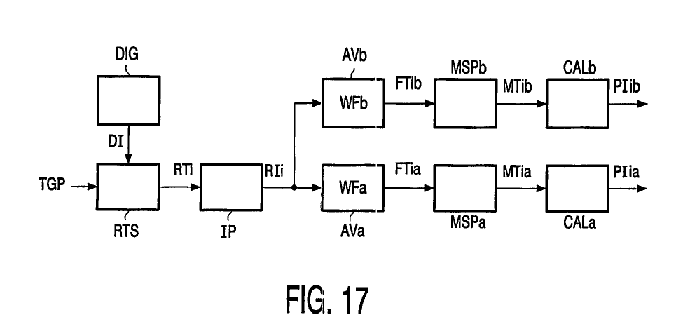

The result of sub-dividing the displacement vector TDV in a number of sub-displacement vectors or segments TDVS1, TDVS2, is that the frame rate of providing the intensities PIi of the pixels Pi (see FIGS. 10 and 17) supplied to the display screen increases. If the displacement vector TDV is sub-divided in N sub-displacement vectors TDVS1, TDVS2, instead of one frame (TFP), N sub-frames (TSFP1, TSFP2) are provided and the frame rate of the displayed information increases with a factor N. These N sub-frames are rendered based on a single sampling of the 3D model including the information to determine the displacement vectorrs TDVS1, TDVS2. The blur size of objects within the sub-frames (TSFP1, TSFP2) is shortened according to the frame rate up-conversion factor N.

FIG. 17 shows a block diagram of a circuit in accordance with an embodiment of the invention comprising the forward texture mapping which generates two motion blurred sub-frames on the basis of a single sampling of the geometry including motion data. FIG. 17 which shows a circuit to obtain a frame rate up-conversion factor of 2 is based on the block diagram shown in FIG. 10 wherein the averager AV, the mapper MSP and the calculator CAL are provided two times to be able to supply the pixel intensities two times per frame. More in general, if a frame rate up-conversion with an integer factor N is desired, N averagers AV, mappers MSP and calculators CAL are provided in parallel. Alternatively, the same single averager AV, mapper MSP and calculator CAL as shown in FIG. 10 may be used which are fast enough to sequentially determine the pixel intensities N times per frame. A combination of both these solutions is also possible.

The operation of the circuit shown in FIG. 17 is elucidated in the now following. The sampler RTS samples within a polygon TGP in the direction of the displacement vector TDV of this polygon TGP to obtain the resampled texels RTi. Therefore, the sampler RTS receives the geometry of the polygon TGP and the displacement information DI from the displacement providing circuit DIG. The displacement information DI may comprise the direction in which the displacement occurs and the amount of displacement and thus may be the displacement vector TDV. The displacement vector TDV may be supplied by the 3D application, or may be determined by the displacement providing circuit DIG from the position of the polygon A in successive frames. The interpolator IP interpolates the intensities of the texels Ti to obtain the intensities RIi of the resampled texels RTi.

In the first branch the one-dimensional filtering ODF comprises an averager AVa which averages the intensities RIi in accordance with a weighting function WF to obtain filtered resampled texels FTia to which is also referred as filtered texels FTia. The mapper MSPa maps the filtered texels FTia within the polygon TGP to the screen space SSP to obtain the mapped texels MTia (see FIG. 4). The calculator CALa determines the intensity contributions of each of the mapped texels MTia to each of the pixels Pi of which a corresponding pre-filter footprint FP of a pre-filter PRF (see FIG. 11) covers one of the mapped texels MTia. The intensity contributions depend on the characteristics of the pre-filter PRF. For example, if the pre-filter has a cubic amplitude characteristic and if a mapped texel MTia is very near to a pixel Pi, the contribution of this mapped texel MTi to the intensity of the pixel Pi is relatively large. If the mapped texel is at the border of the footprint FP of the prefilter which is centered at a pixel Pi, the contribution of the mapped texel MTia is relatively small. If the mapped texel MTia is not within the footprint FP of the prefilter of a particular pixel Pi, this mapped texel MTia will not contribute to the intensity of the particular pixel Pi. The calculator CALa sums all the contribution of the different mapped texels MTia to the pixels Pi to obtain the intensities PIia of the pixels Pi. The intensity PIia of a particular pixel Pi only depends on the intensities of the mapped texels MTia within the footprint FP belonging to this particular pixel Pi and the amplitude characteristic of the pre-filter. Thus for a particular pixel Pi only the contributions of the mapped texels MTia within the footprint FP belonging to this particular pixel Pi need to be summed.

In the second branch the one-dimensional filtering ODF comprises an averager AVb which averages the intensities RIi in accordance with a weighting function WF to obtain filtered resampled texels FTib to which is also referred as filtered texels FTib. The mapper MSPb maps the filtered texels FTib within the polygon TGP to the screen space SSP to obtain the mapped texels MTib. The calculator CALb determines the intensity contributions of each of the mapped texels MTib to each of the pixels Pi of which a corresponding pre-filter footprint FP of a pre-filter PRF (see FIG. 11) covers one of the mapped texels MTib in the same manner as elucidated with respect the the calculater CALa.

To conclude, in a preferred embodiment, the invention is directed to a method of generating motion blur in a 3D-graphics system. A geometrical information GI defining a shape of a graphics primitive SGP or TGP is received RSS; RTS from a 3D-application. A displacement vector SDV; TDV defining a direction of motion of the graphics primitive SGP or TGP is also received from the 3D-application or is determined from the geometrical information. The graphics primitive SGP or TGP is sampled RSS; RTS in the direction indicated by the displacement vector SDV; TDV to obtain input samples RPi, and an one dimiensional spatial filtering ODF is performed on the input samples RPi to obtain temporal pre-filtering.

It should be noted that the above-mentioned embodiments illustrate rather than limit the invention, and that those skilled in the art will be able to design many alternative embodiments without departing from the scope of the appended claims. For example, in many of the embodiments above, the processing of only one polygon is elucidated. In a practical application a huge amount of polygons (or more general: graphics primitives) may have to be processed for a complete image.

In the claims, any reference signs placed between parenthesis shall not be construed as limiting the claim. The word “comprising” does not exclude the presence of other elements or steps than those listed in a claim. The invention can be implemented by means of hardware comprising several distinct elements, and by means of a suitably programmed computer. In the device claim enumerating several means, several of these means can be embodied by one and the same item of hardware.

1. A method of generating motion blur in a graphics system, the method comprising:
receiving (RA; RSS; RTS) geometrical information (GI) defining a shape of a graphics primitive (SGP,TGP),
providing (DIG) displacement information (DI) determining a displacement vector (SDV;TDV) defining a direction of motion of the graphics primitive (SGP; TGP),
sampling (RA; RSS; RTS) the graphics primitive (SGP; TGP) in the direction indicated by the displacement vector (SDV;TDV) to obtain input samples (RPi; RIi), and
one dimensional spatial filtering (ODF) of the input samples (RPi; RIi) to obtain temporal pre-filtering.

2. A method as claimed in claim 1, wherein the step of providing (DIG) displacement information (DI) further defines an amount of motion of the graphics primitive (SGP; TGP), and wherein the step of one dimensional spatial filtering (ODF) is arranged to obtain the temporal pre-filtering with a size of a filter footprint (FP) that depends on the magnitude of the displacement vector (SDV;TDV).

3. A method as claimed in claim 1, wherein the displacement vector (SDV;TDV) is supplied by a 2D or a 3D application.

4. A method as claimed in claim 1, wherein the step of providing (DIG) displacement information (DI) receives a model-view transformation matrix from a 2D or a 3D application, said matrix defining the position and orientation of the graphics primitive (SGP; TGP) of a previous frame.

5. A method as claimed in claim 1, wherein the step of providing (DIG) displacement information (DI) buffers a position and an orientation of the graphics primitive (SGP; TGP) of a previous frame to calculate the displacement vector (SDV;TDV).

6. A method as claimed in claim 1, wherein
the graphics system is arranged for displaying pixels (Pi) having a pixel intensity (PIi) on a display screen (DS), the pixels (Pi) being positioned on pixel positions (x,y) in a screen space (SSP),
the step of sampling (RA; RSS; RTS) is adapted for sampling (RSS) in the screen space (SSP) in a direction of a screen displacement vector (SDV) being the displacement vector mapped to the screen space (SSP) to obtain resampled pixels (RPi),
the method further comprises an inverse texture mapping (ITM) receiving coordinates of the resampled pixels (RPi) to supply intensities (RIp) of the resampled pixels (RPi),
the step of one dimensional spatial filtering (ODF) comprises averaging (AV) of the intensities (RIp) of the resampled pixels (RPi) to obtain averaged intensities (ARIp) in accordance with a weighting function (WF),
the method further comprises a resampling (RSA) of the averaged intensities (ARIp) of the resampled pixels (RPi) to obtain the pixel intensities (PIi).

7. A method as claimed in claim 1, wherein
the graphics system is arranged for displaying pixels (Pi) having a pixel intensity (PIi) on a display screen, the pixels (Pi) being positioned on pixel positions (x,y) in a screen space (SSP),
the method further comprises providing appearance information (TA, TB) defining an appearance of the graphics primitive (SGP) in the screen space (SSP) by defining texel intensities (Ti) in a texture space (TSP),
the step of sampling (RA; RSS; RTS) is adapted for sampling (RTS) in the texel space (TSP) in a direction of a texel displacement vector (TDV) being the displacement vector mapped to the texel space (TSP) to obtain resampled texels (RTi),
the method further comprising interpolating (IP) the texel intensities (Ti) to obtain intensities (RIi) of the resampled texels (RTi),
the step of one dimensional spatial filtering (ODF) comprises averaging (AV) the intensities (RIi) of the resampled texels (RTi) in accordance with a weighting function (WF) to obtain filtered texels (FTi),
the method further comprises:
mapping (MSP) the filtered texels (FTi) of the graphics primitive (TGP) in the texture space (TSP) to the screen space (SSP) to obtain mapped texels (MTi),
determining (CAL) intensity contributions from a mapped texel (MTi) to all the pixels (Pi) of which a corresponding pre-filter footprint (PFP) of a pre-filter (PRF) covers the mapped texel (MTi), the contribution being determined by an amplitude characteristic of the pre-filter (PRF), and
summing (CAL) the intensity contributions of the mapped texel (MTi) for each pixel (Pi).

8. A method as claimed in claim 6, wherein at least a direction of the displacement vector (SDV;TDV) of the graphics primitive (GP) is an average of directions of displacement vectors of vertices of the graphics primitive.

9. A method as claimed in claim 6, wherein the step of one dimensional filtering (ODF) comprises:
distributing, in the screen space (SSP), the intensities (RIp) of the resampled pixels (RPi) in a direction of the displacement vector (SDV) over a distance determined by a magnitude of the displacement vector (SDV) to obtain distributed intensities (DIi), and
averaging overlapping distributed intensities (DIi) of different pixels (Pi) to obtain a piece-wise constant signal being the averaged intensities (ARPi).

10. A method as claimed in claim 7, wherein the step of one dimensional filtering (ODF) comprises:
distributing, in the texture space (TSP), the intensities (RIi) of the resampled texels (RTi) in a direction of the displacement vector (TDV) over a distance determined by a magnitude of the displacement vector (TDV) to obtain distributed intensities (TDIi), and
averaging overlapping distributed intensities (TDIi) of different resampled texels (RTi) to obtain a piece-wise constant signal being the filtered texels (FTi).

11. A method as claimed in claim 7, wherein the step of one dimensional spatial filtering (ODF) is arranged for applying a weighted averaging function (WF) during at least one frame-to-frame interval.

12. A method as claimed in claim 9, wherein the distance is rounded to a multiple of the distance (DIS) between resampled texels (RTi).

13. A method as claimed in claim 1, wherein
the graphics system is arranged for displaying pixels (Pi) having a pixel intensity (PIi) on a display screen, the pixels (Pi) being positioned on pixel positions (x,y) in a screen space (SSP),
the method further comprises the step of providing appearance information (TA, TB) defining an appearance of the graphics primitive (SGP) in the screen space (SSP) by defining texel intensities (Ti) in a texture space (TSP),
the step of sampling (RA; RSS; RTS) is adapted for sampling (RTS) in the texel space (TSP) in a direction of a texel displacement vector (TDV) being the displacement vector mapped to the texel space (TSP) to obtain resampled texels (RTi),
the method further comprising interpolating (IP) the texel intensities (Ti) to obtain intensities (RIi) of the resampled texels (RTi),
the step of one dimensional spatial filtering (ODF) comprises
subdividing the displacement vector (TDV) in a predetermined number of segments ( ) to obtain segment displacement vectors (STDV), and for each one of the segments ( ):
distributing, in the texture space (TSP), the intensities (RIi) of the resampled texels (RTi) with a direction, a position and a magnitude according to an associated one of the segment displacement vectors (STDV) to obtain averaged overlapping distributed intensities (TDIi) of different resampled texels (RTi) to obtain a piece-wise constant signal being the motion blurred filtered texels (FTi),
the method further comprises for each one of the segments ( ):
mapping (MSP) the filtered texels (FTi) of the graphics primitive (TGP) in the texture space (TSP) to the screen space (SSP) to obtain mapped texels (MTi),
determining (CAL) intensity contributions from a mapped texel (MTi) to all the pixels (Pi) of which a corresponding pre-filter footprint (PFP) of a pre-filter (PRF) covers the mapped texel (MTi), the contribution being determined by an amplitude characteristic of the pre-filter (PRF), and
summing (CAL) the intensity contributions of the mapped texel (MTi) for each pixel (Pi).

14. A graphics computer system comprising:
means for receiving (RA; RSS; RTS) geometrical information (GI) defining a shape of a graphics primitive (SGP,TGP),
means for providing (DIG) displacement information (DI) determining a displacement vector (SDV;TDV) defining a direction of motion of the graphics primitive (SGP; TGP),
means for sampling (RA; RSS; RTS) the graphics primitive (SGP; TGP) in the direction indicated by the displacement vector (SDV;TDV) to obtain input samples (RPi; RIi), and
means for one dimensional spatial filtering (ODF) of the input samples (RPi; RIi) to obtain temporal pre-filtering.
